(19) United States
(12) Patent Application Publication
(10) Pub. No.: US 2016/0058157 A1
(43) Pub. Date: Mar. 3, 2016

(54) Head-Mounted Ear Mirror Assembly

(71) Applicant: William Hefner, Mesquite, TX (US)

(72) Inventor: William Hefner, Mesquite, TX (US)

(21) Appl. No.: 14/475,667

(22) Filed: Sep. 3, 2014

(51) Int. Cl. A45D 42/12; A45D 42/10; F21L 4/00; G02B 17/06

(52) U.S. Cl. CPC A45D 42/12; G02B 17/0605; A45D 42/10; F21L 4/00; F21Y 2101/02

(57) ABSTRACT

A head-mounted mirror assembly includes a semi-rigid headband having a pair of free ends, each having a fastener proximal thereto for adjustably fastening the band around a wearer's head. A pair of shafts, each with an adjustable mirror at a distal end, extends outwardly from the band. Mounted on each shaft, near the mirror, is an LED having a light output directed toward the headband. To view an ear, a user secures the headband to the head and positions one of the mirrors to align with the ear and the other mirror to substantially align with the nearest eye. Each mirror is adjusted so that the wearer can easily view a desired portion of the ear by observing the mirror in front of the eye. If necessary, the wearer can activate the LED on the side mirror to direct a light beam into the ear cavity.

### BACKGROUND OF THE INVENTION

The present invention relates to a head-mounted mirror that allows a wearer to easily view his or her ear.

To perform certain hygienic or medical procedures within the ear, a person often must observe the ear cavity, which can be difficult without assistance. Typically, one must use a combination of a stationary mirror, a handheld mirror and a flashlight, which occupy both hands that are otherwise needed to perform the desired procedure. Accordingly, there is currently a need for a device that allows a user to easily view his or her ear. The present invention addresses this need by providing a head-mounted mirror assembly that allows the wearer to easily view the ear while freeing the hands for other tasks.

### SUMMARY OF THE INVENTION

The present invention relates to a head-mounted mirror assembly comprising a semi-rigid headband having a pair of free ends, each having a fastener proximal thereto for adjustably fastening the band around a wearer's head.

A pair of shafts, each with an adjustable mirror at a distal end, extend outwardly from the band. Mounted on each shaft, near the mirror, is an LED having a light output directed toward the headband. To view an ear, a user secures the headband to the head and positions one of the mirrors to align with the ear and the other mirror to substantially align with the nearest eye. Each mirror is adjusted so that the wearer can easily view a desired portion of the ear by observing the mirror in Front of the eye. If necessary, the wearer can activate the LED on the side mirror to direct a light beam into the ear cavity.

It is therefore an object of the present invention to provide a mirror assembly that allows a user to easily view his or her ear.

It is another object of the present invention to provide a mirror assembly that is mounted on a user's head to free the hands for other tasks. Other objects, features, and advantages of the present invention will become readily apparent from the following detailed description of the preferred embodiment when considered with the attached drawings and the appended claims.

### BRIEF DESCRIPTION OF THE DRAWINGS

FIG. 1 depicts a user wearing the mirror assembly according to the present invention.

FIG. 2 is a top view of the mirror assembly.

FIG. 3 is a top view of the mirror assembly of FIG. 2 rotated to view an opposite ear.

FIG. 4 is an isolated, detailed view of the ball-and-socket joint for each mirror.

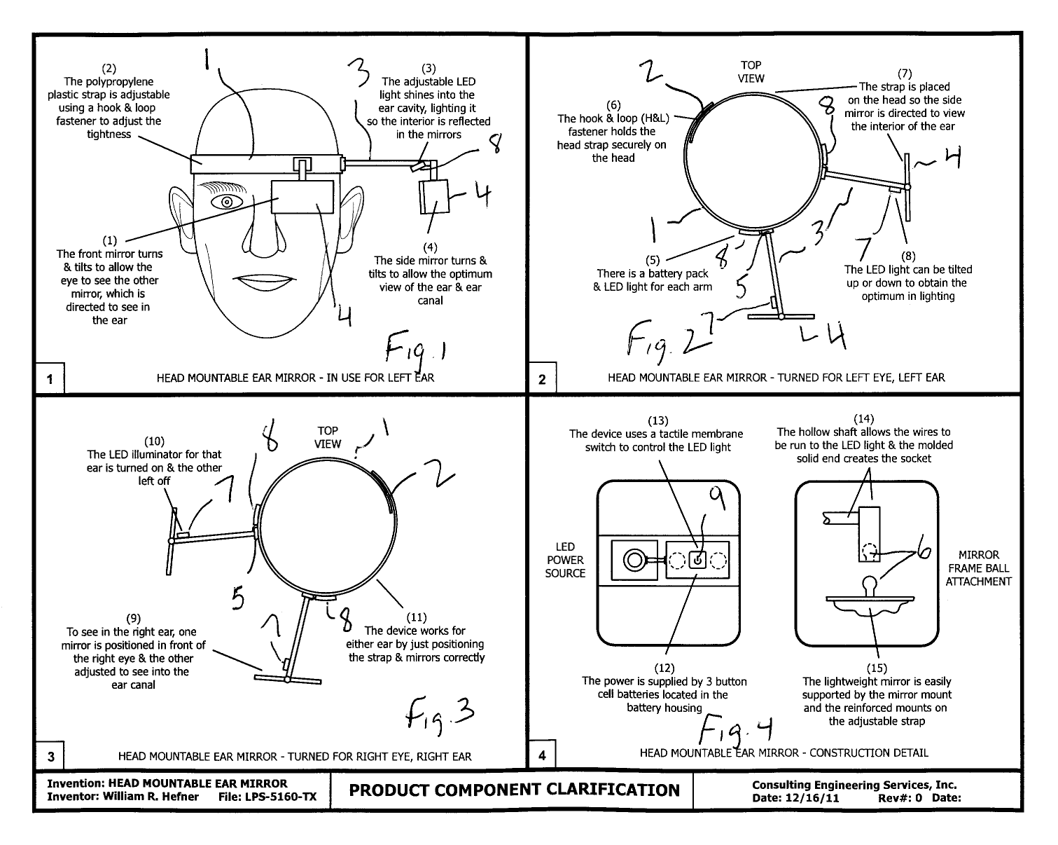

### DETAILED DESCRIPTION OF THE PREFERRED EMBODIMENT

The present invention relates to a head-mounted mirror assembly comprising a semi-rigid headband 1 having a pair of free ends, each having a fastener 2 proximal thereto for adjustably fastening the band around a wearer's head. In the preferred embodiment, the fastener is a hook-and-loop patch that overlaps the other patch in a select location to vary the headband circumference. Outwardly extending from the band is a pair of shafts 3, each having an adjustable mirror 4 at a distal end. Preferably, the shafts are relatively spaced at slightly less than ninety-degrees so that one mirror aligns with a wearer's ear while the other simultaneously aligns with an eye when the headband is worn. The proximal end of each shaft is slide mounted within a mating channel 5 on the headband exterior. Preferably, the mirror is connected to the shaft with a ball-and socket joint 6 that allows the mirror to be easily adjusted within the x, y and z planes. Either or both mirrors could also be concave to magnify reflected images.

Mounted on each shaft, near the mirror, is an adjustable LED 7 having a light output directed toward the headband. Each LED is electrically connected to a battery housing 8 mounted on the headband, near the proximal end of the shaft. A button 9 on the battery housing allows the wearer to activate the LED when illumination is needed.

To view an ear, a user secures the headband to the head and positions one of the mirrors to align with the ear and the other mirror to substantially align with the nearest eye. Each mirror is adjusted so that the wearer can easily view a desired portion of the ear by observing the mirror in front of the eye. If necessary, the wearer can activate the LED on the side mirror to direct a light beam into the ear cavity. If the wearer wishes to view the other ear, the band is simply rotated slightly to position the side mirror in front of the eyes, which simultaneously shifts the front mirror to align with the other ear.

The above-described device is not limited to the exact details of construction and enumeration of parts provided herein. Furthermore, the size, shape and materials of construction of the various components can be varied.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims.

What is claimed is:

1. Head-Mounted Ear Mirror Assembly, the device comprising of a semi-rigid headband having a pair of free ends, each having a fastener proximal thereto for adjustably fastening the band around a wearer's head in which the fastener is a hook-and-loop patch that overlaps the other patch in a select location to vary the headband circumference.

2. The system of claim 1, further comprising of outwardly extending pair of shafts, each having an adjustable mirror at a distal end so that one mirror aligns with a wearer's ear while the other simultaneously aligns with an eye when the headband is worn.

3. The system of claim 1, further consists of the proximal end of each shaft which is slide mounted within a mating channel on the headband exterior in which the mirror is connected to the shaft with a ball-and socket joint that allows the mirror to be easily adjusted within the x, y and z planes.

4. The system of claim 1, further comprises of either or both mirrors could be concave to magnify reflected images.

5. The system of claim 1, further comprising of an adjustable LED having a light output directed toward the headband and each LED is electrically connected to a battery housing mounted on the headband, near the proximal end of the shaft in which a button on the battery housing allows the wearer to activate the LED when illumination is needed.

6. They system of claim 1, states that the size, shape and materials of construction of the various components can be varied and may be modified in the future and therefore, the scope of the invention is only to be limited by these claims.
